(19) United States
(12) Patent Application Publication
(10) Pub. No.: US 2014/0148976 A1
(43) Pub. Date: May 29, 2014

(54) VEHICLE CONTROL SYSTEM

(71) Applicant: HYUNDAI MOTOR COMPANY, Seoul (KR)

(72) Inventors: Jungsang MIN, Seoul (KR); Gi Beom HONG, Bucheon-si (KR); Sung Un KIM, Yongin-si Gyeonggi-do (KR)

(73) Assignee: HYUNDAI MOTOR COMPANY, Seoul (KR)

(21) Appl. No.: 14/058,004

(22) Filed: Oct. 18, 2013

(30) Foreign Application Priority Data
Nov. 23, 2012 (KR) 10-2012-0133821

(51) Int. Cl. B60R 16/037

(52) U.S. Cl. CPC B60R 16/0373
USPC 701/2; 701/36

(57) ABSTRACT

A vehicle control system includes a plurality of operation input units configured to input a manual operation from a user as an input signal, the input units being installed in a plurality of predetermined positions within a vehicle. A reading unit is configured to read a vehicle control signal corresponding to the input signal, and a control unit is configured to control an audio & video (AV) device or an air-conditioning device by the vehicle control signal. The plurality of operation input units are installed adjacent to a manipulation unit of the AV device and a manipulation unit of the air-conditioning device to input the input signal for controlling the AV device and the air-conditioning device.

### CROSS-REFERENCE TO RELATED APPLICATION

This application claims priority to and benefit from Korean Patent Application No. 10-2012-0133821 filed in the Korean Intellectual Property Office on Nov. 23, 2012, the entire contents of which are incorporated herein by reference.

### BACKGROUND

1. Technical Field The present disclosure relates to a vehicle control system and, more particularly, to a vehicle control system capable of controlling convenient devices within a vehicle through a driver's manual operation (or a driver's hand motion).

2. Background

Various convenient devices may be installed in a vehicle. Convenient devices installed in most vehicles include an audio & video (AV) device outputting a voice or an image and an air-conditioning device serving as an air-conditioner or a heater.

In order to control such an AV device or air-conditioning device, manipulation units of the AV device and the air-conditioning device are positioned at a front side within a vehicle.

For example, in order to listen to a radio broadcast, a driver may press an ON/OFF button located on the manipulation unit of the AV device and manipulate a frequency control button to change a radio frequency. In order to cool an indoor area, the driver may press an ON/OFF button installed on a manipulation unit of the air-conditioning device and manipulate a temperature control button to control an internal temperature.

In this manner, the driver should directly manipulate multiple buttons in order to use the AV device or the air-conditioning device.

However, even while driving, the driver is required to check a button position with his eyes to press a button. If the driver attempts to view the front side of the vehicle while he is manipulating buttons during high speed driving, an accident may occur.

The above information disclosed in this Background section is only for enhancement of understanding of the background of the disclosure.

### SUMMARY

To overcome the disadvantages described above, the present disclosure provides a vehicle control system having advantages of controlling an audio & video (AV) device and an air-conditioning device through a driver's manual operation.

An exemplary embodiment of the present disclosure provides a vehicle control system including: a plurality of operation input units configured to input a manual operation, the input units being installed in a plurality of predetermined positions within a vehicle, as an input signal; a reading unit configured to read a vehicle control signal corresponding to the input signal; and a control unit configured to control an audio & video (AV) device or an air-conditioning device by the vehicle control signal, wherein the plurality of operation input units are installed to be adjacent to a manipulation unit of the AV device and a manipulation unit of the air-conditioning device to input the input signal for controlling the AV device and the air-conditioning device.

The operation input unit may be configured to input a manual operation as an input signal for at least any one of a camera and an ultrasonic wave sensor.

The vehicle control system may further include: a voice guidance unit configured to provide the vehicle control signal corresponding to the input signal by voice.

The vehicle control system may further include: a display unit configured to display the vehicle control signal corresponding to the input signal by characters or a picture.

According to embodiments of the present disclosure, a driver can control an AV device or an air-conditioning device by a manual operation without having to view a manipulation unit of the AV device or the air-conditioning device, and thus, an accident caused by the driver's manipulation can be prevented.

### BRIEF DESCRIPTION OF THE DRAWINGS

FIG. 1 is a block diagram of a vehicle control system according to an embodiment of the present disclosure.

FIG. 2 is a flow chart illustrating an operation of controlling an AV device through a manual operation of a driver.

### DETAILED DESCRIPTION OF THE EMBODIMENTS

Hereinafter, the present disclosure will be described more fully with reference to the accompanying drawings, in which exemplary embodiments of the disclosure are shown. The described embodiments may be modified in various different ways, all without departing from the spirit or scope of the present disclosure. The drawings and description are to be regarded as illustrative in nature and not restrictive. Like reference numerals designate like elements throughout the specification.

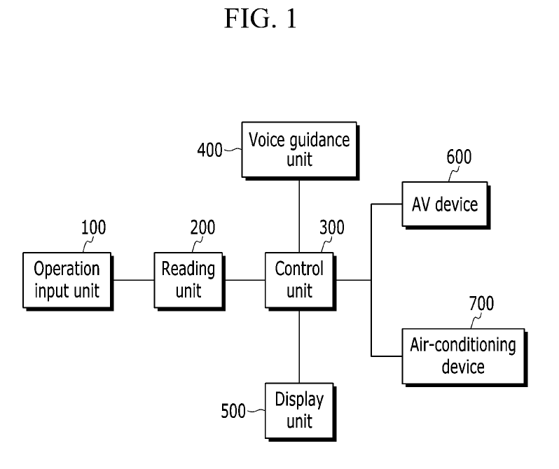

Referring to FIG. 1, according to an embodiment of the present disclosure, a vehicle control system which controls an AV device or an air-conditioning device installed within a vehicle through a manual operation of a user, such as a driver, includes an operation input unit 100, a reading unit 200, and a control unit 300.

According to an embodiment of the present disclosure, the operation input unit 100 may receive a manual operation of a driver, as an input signal.

In some examples, the operation input unit 100 may be a camera. When the driver, while driving, performs a particular operation with his finger, the camera may capture an image of the manual operation. Namely, the operation input unit 100 may receive a captured image as an input signal.

For example, when the driver draws a circle with his right index finger, the camera as the operation input unit 100 captures a corresponding image and receives the captured image of the circle drawn by the right index finger, as an input signal.

In another example, the operation input unit 100 may be an ultrasonic wave sensor, as well as being a camera. Any known ultrasonic wave sensor capable of detecting an operation upon sensing a change in ultrasonic waves and suitable for use in a vehicle may be used as the operation input unit. Thus, a detailed description of the ultrasonic wave sensor will be omitted.

In some examples, only one of the camera or the ultrasonic wave sensor may be installed as the operation input unit 100. In other examples, both the camera and the ultrasonic wave sensor may be installed to accurately recognize a manual operation.

The operation input units 100 may be installed in a plurality of predetermined positions within the vehicle. The plurality of operation input units 100 may be installed to be adjacent to the manipulation units (not shown) of the AV device and the air-conditioning device within the vehicle, respectively.

In an example, the plurality of operation input units 100 installed to be adjacent to the manipulation units of the AV device and the air-conditioning device may receive an input signal for controlling the AV device and the air-conditioning unit, respectively.

For example, the operation input unit installed adjacent to the manipulation unit of the AV device may receive a manual operation of the driver drawn on a front surface of the manipulation unit of the AV device, as an input signal, and in this case, the input signal is received as a signal for controlling the AV device.

Also, the operation input unit installed adjacent to the manipulation unit of the air-conditioning device receives the manual operation of the driver drawn on the front surface of the manipulation unit, as an input signal.

According to an embodiment of the present disclosure, the reading unit 200 searches for a vehicle control signal corresponding to the input signal input through the operation input unit 100.

In one example, the vehicle control signal represents a control signal of a device installed within the vehicle intended by the driver. For example, the vehicle control signal corresponds to a signal for turning on or turning off power of the AV device, a signal for turning up or turning down the volume of the AV device, a signal for turning on or turning off power of the air-conditioning device, a signal for increasing or decreasing a pre-set temperature of the air-conditioning device, or the like.

Namely, the reading unit 200 serves to search for a vehicle control signal mapped to the input signal.

For example, an input signal formed by the driver drawing a circle with his finger on a front surface of the manipulation unit of the AV device may correspond to and be mapped to a vehicle control signal for turning on or turning off the AV signal. As a result, the reading unit 200 may analyze the input signal and search for an ON/OFF signal of the AV signal mapped to the input signal among various types of vehicle control signals.

In an example, the reading unit 200 may store the input signal in the form of an image and analyze the same. In detail, the input signal captured by the operation input unit 100 may be stored as an image, e.g., an image file in which a circle is drawn.

For example, the reading unit 200 may include a storage unit (not shown) storing various types of vehicle control signals. The storage unit may store the vehicle control signals in the form of a database.

Thus, the reading unit 200 may analyze the image file converted from the input signal, and search for a vehicle control signal corresponding to the image file from the storage unit.

According to an embodiment of the present disclosure, the control unit 300 may control a device installed within the vehicle by the vehicle control signal searched by the reading unit 200.

Referring to FIG. 1, the control unit 300 may control the AV device and the air-conditioning device installed within the vehicle.

The control unit 300 may perform a function corresponding to each vehicle control signal. For example, when the control unit 300 receives a control signal for turning on or turning off the AV device from the reading unit 200, the control unit 300 may serve to turn on or turn off the AV device.

For example, the control unit 300 may control any other convenient device installed within the vehicle, rather than being limited to the AV device or the air-conditioning device.

Meanwhile, the vehicle control system according to an embodiment of the present disclosure may further include a voice guidance unit 400 providing the vehicle control signal corresponding to the input signal by voice.

Referring to FIG. 1, the voice guidance unit 400 may guide the corresponding vehicle control signal by voice.

For example, when the driver draws a circle with his finger on a front surface of the manipulation unit of the AV device, the voice guidance unit 400 may provide content of turning on or turning off the AV device, denoted by the vehicle control signal, by voice.

Namely, in a state in which the AV device is in an OFF state, when the driver draws a circle on a front surface of the AV device, the voice guidance unit 400 may provide a guidance message such as “AV device is driven” by voice.

Meanwhile, in a case in which the input signal input through the operation input unit 100 cannot be read by the reading unit 200, or in a case in which there is no corresponding vehicle control signal in the storage unit of the reading unit 200, the voice guidance unit 400 may provide a message indicating that a manual operation should be input again.

In an example, the voice guidance unit 400 may provide a voice through a speaker installed within the vehicle.

Since the voice guidance unit 400 provides the vehicle control signal, information such as an error of the manual operation, or the like, to the driver by voice, the driver can determine whether the manual operation performed by him while driving has been properly performed. Thus, the driver does not need to view the AV device or the air-conditioning device directly with his eyes, thereby promoting safety.

According to an embodiment of the present disclosure, the vehicle control system may further include a display unit 500 for displaying the vehicle control signal corresponding to the input signal by characters or a picture.

The display unit 500 may display a vehicle control signal corresponding to a manual operation of the driver.

For example, as described above, when the driver performs an operation of drawing a circle with his finger on a front surface of the AV device and the reading unit 200 reads the input signal as a vehicle control signal for turning on or turning off the AV device, the display unit may display characters or a picture of content such as ‘AV device ON’.

In an example, the display unit 500 may display the characters or the picture through a screen installed within the vehicle. Recently, guidance characters or picture may be displayed by using a display installed in an audio video navigation (AVN) installed within a vehicle.

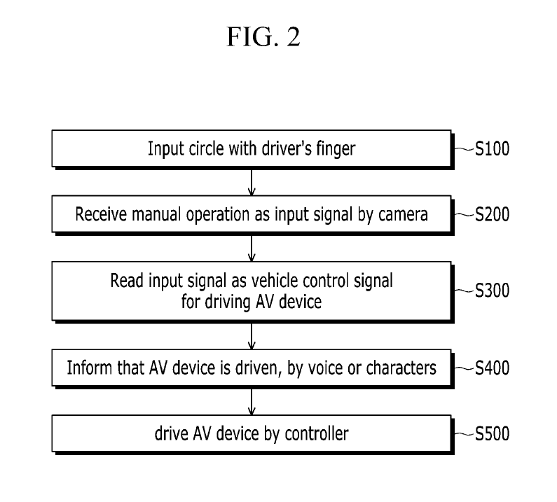

FIG. 2 is a flow chart illustrating an operation of controlling an AV device through a manual operation of a driver.

Referring to FIG. 2, the order of operation for controlling an AV device installed within a vehicle is controlled by the vehicle control system according to an embodiment of the present disclosure.

In one example, the operation of drawing a circle with the user's finger on the front surface of the manipulation unit of the AV device corresponds to a function of turning on or turning off power of the AV device.

When the driver wants to use an AV device, the driver first draws a circle with the index finger of his right hand on the front surface of the manipulation unit of the AV device while driving (S100).

After the driver draws the circle, the operation input unit 100 installed adjacent to the manipulation unit of the AV device receives the manual operation of the driver, as an input signal (S200). When a camera is installed as the operation input unit 100, the camera captures an image of the manual operation of the driver.

Thereafter, the reading unit 200 analyzes the image signal captured by the camera. In an example, the reading unit 200 may store the input signal in the form of an image, and analyze the same. In this case, the reading unit 200 reads the input signal as a vehicle control signal for operating the AV device (S300).

For example, when the AV device is in an OFF state, the reading unit 200 may read the input signal as a vehicle control signal for using (or turning on) the AV device. Conversely, when the AV device is in an OFF state, the reading unit 200 may read the input signal as a vehicle control signal for terminating (or turning off) the AV device.

Thereafter, the voice guidance unit 400 and the display unit 500 may provide content corresponding to the vehicle control signal by voice, characters, or the like (S400). For example, when the vehicle control signal is a control signal for using (ON) the AV device, the voice guidance unit 400 and the display unit 500 may provide corresponding content to the driver by voice or characters.

Finally, the control unit 300 may control the AV device or the air-conditioning device installed within the vehicle according to the vehicle control signal. For example, when the vehicle control signal is a signal for using (ON) the AV device, the control unit 300 operates the AV device (S500).

However, the guiding step (S400) by the voice guidance unit 400 and the display unit 500 and the control step (S500) by the control unit 300 may be simultaneously performed.

The vehicle control system according to an embodiment of the present disclosure can control the AV device or the air-conditioning device through a manual operation on the front surface of each device, and thus, the driver can control the convenient device such as the AV device or the air-conditioning device without a corresponding decrease in safe operation of the vehicle.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims. Therefore, the embodiments described above are illustrative in every aspect and are not limited.

What is claimed is:

1. A vehicle control system comprising:
a plurality of operation input units configured to input a manual operation from a user as an input signal, the operation input units being installed in a plurality of predetermined positions within a vehicle;
a reading unit configured to read a vehicle control signal corresponding to the input signal; and
a control unit configured to control an audio & video (AV) device or an air-conditioning device by the vehicle control signal,
wherein the plurality of operation input units are installed adjacent to a manipulation unit of the AV device and a manipulation unit of the air-conditioning device to input the input signal for controlling the AV device and the air-conditioning device.

2. The vehicle control system of claim 1, wherein the operation input unit is configured to operate at least any one of a camera and an ultrasonic wave sensor.

3. The vehicle control system of claim 1, further comprising:
a voice guidance unit providing the vehicle control signal corresponding to the input signal by voice.

4. The vehicle control system of claim 3, further comprising:
a display unit configured to display the vehicle control signal corresponding to the input signal by characters or a picture.
